(19) United States
(12) Patent Application Publication
(10) Pub. No.: US 2017/0288596 A1
(43) Pub. Date: Oct. 5, 2017

(54) CONTROL DEVICE FOR MOTOR HAVING PLURALITY OF WINDINGS

(71) Applicant: FANUC CORPORATION, Yamanashi (JP)

(72) Inventors: Satoshi IKAI, Yamanashi (JP); Kenichi TAKAYAMA, Yamanashi (JP)

(21) Appl. No.: 15/464,465

(22) Filed: Mar. 21, 2017

(30) Foreign Application Priority Data
Mar. 31, 2016 (JP) 2016-071096

(51) Int. Cl. H02P 29/024; H02P 6/14; H02P 27/06

(52) U.S. Cl. CPC H02P 29/024; H02P 27/06; H02P 6/14

(57) ABSTRACT

A control device for a motor is provided that can determine the states of current controllers controlling the current flowing to windings, as well as reducing the load of arithmetic processing. A control device for a motor having windings includes: a main current controller that is connected with a numerical control and controls current flowing to the winding; and sub-current controllers that are connected with the main current controller and control current flowing to the windings, respectively, in which the main current controller: calculates states of the main current controller and the sub-current controllers, compares between the states of the main current controller and the sub-current controllers thus calculated, and determines whether an abnormality is occurring in the main current controller and the sub-current controllers based on a result of comparing between the states of the main current controller and the sub-current controllers.

This application is based on and claims the benefit of priority from Japanese Patent Application No. 2016-071096, filed on 31 Mar. 2016, the content of which is incorporated herein by reference.

### BACKGROUND OF THE INVENTION

### Field of the Invention

The present invention relates to a control device for motors having a plurality of windings.

### Related Art

Conventionally, technology has been known that drives one motor having a plurality of windings inside by a plurality of inverters in order to realize larger capacity in a motor such as a servo motor (e.g., refer to Patent Document 1).

With such a motor having a plurality of windings, the current flowing to each of the plurality of windings is controlled by a plurality of current controllers corresponding to each winding. Normally, the plurality of current controllers determines abnormality in the current flowing to each winding by the respective current controllers, and notifies of the abnormality in current to a numerical control for every current controller (e.g., refer to Patent Documents 2 and 3).

Patent Document 1: Japanese Unexamined Patent Application, Publication No. 2011-030354

Patent Document 2: Japanese Unexamined Patent Application, Publication No. 2013-255330

Patent Document 3: Japanese Unexamined Patent Application, Publication No. 2013-038950

### SUMMARY OF THE INVENTION

However, in order to drive the same motor, it is necessary for the state of each current controller controlling the current flowing to each winding to be identical between each current controller. In addition, upon determining the state of the current controllers, it is desirable to reduce the load of arithmetic processing on the motor control device.

Therefore, the present invention has an object of providing a motor control device that can determine the state of current controllers controlling the current flowing to the windings, as well as reduce the load of arithmetic processing.

A control device (e.g., the control device 1 for a motor described later) for a motor having a plurality of windings (e.g., the winds 31a, 31b, 31c, 31d described later), includes: a main current controller (e.g., the main current controller 11a described later) that is connected with a numerical control (e.g., the numerical control 2 described later) and controls current flowing to one winding among the plurality of windings; and sub-current controllers (e.g., the sub-current controllers 11b, 11c, 11d described later) that are connected with the main current controller and control current flowing to each of other windings among the plurality of windings, respectively, in which the main current controller: calculates states of the main current controller and the sub-current controllers, compares between the states of the main current controller and the sub-current controllers thus calculated, and determines whether an abnormality is occurring in the main current controller and the sub-current controllers based on a result of comparing between the states of the main current controller and the sub-current controllers.

The main current controller may: calculate an average value for the states of the main current controller and the sub-current controllers; compares between a value of one state among the main current controller and the sub-current controllers with an average value of other states among the main current controller and the sub-current controllers; and determine that an abnormality is occurring in the main current controller and the sub-current controllers, in a case of a difference between the value of the one state and the average value of the other states being greater than a threshold.

The main current controller may: calculate a logical sum of the states of the main current controller and the sub-current controllers; compare between one state among the main current controller and the sub-current controllers with a logical sum of other states among the main current controller and the sub-current controllers; and determine that an abnormality is occurring in the main current controller and the sub-current controllers, in a case of the one state and the logical sum of the other states being different.

The main current controller may: calculate a logical product of the states of the main current controller and the sub-current controllers; compare between one state of among the main current controller and the sub-current controllers with a logical product of other states among the main current controller and the sub-current controllers; and determine that an abnormality is occurring in the main current controller and the sub-current controllers, in a case of the one state and the logical product of the other states being different.

The main current controller may: calculate states of the main current controller and the sub-current controllers; compare between the states of the main current controller and the sub-current controllers, respectively; and count a number of same states among the states of the main current controller and the sub-current controllers, and determines that an abnormality is occurring in the main current controller and the sub-current controllers, which is in a state having a small number of the same states.

The main current controller may, in a case of determining that an abnormality is occurring in the main current controller and the sub-current controllers, send an abnormality notification of the main current controller and the sub-current controllers, and information of windings corresponding to the main current controller and the sub-current controllers in which an abnormality occurred, to the numerical control; and the numerical control may inform, by a predetermined mode, the abnormality notification of the main current controller and the sub-current controllers, and the information of windings corresponding to the main current controller and the sub-current controllers in which the abnormality occurred.

According to the present invention, it is possible to determine the state of current controllers controlling the current flowing to windings, as well as reduce the load of arithmetic processing.

### BRIEF DESCRIPTION OF THE DRAWINGS

FIG. 1 is a diagram showing the functional configuration of a motor control device according to an embodiment of the present invention; and

FIG. 2 is a chart showing an example of processing of the motor control device according to the embodiment of the present invention.

### DETAILED DESCRIPTION OF THE INVENTION

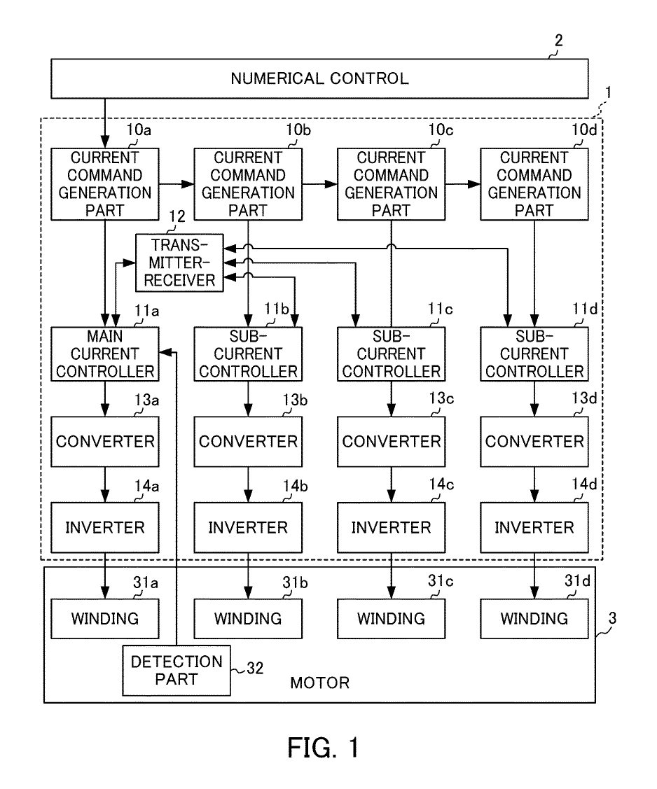

Hereinafter, an example of an embodiment of the present invention will be explained. FIG. 1 is a block diagram showing the functional configuration of a motor control device 1 according to the present embodiment. As shown in FIG. 1, the motor control device 1 includes current command parts 10a, 10b, 10c and 10d; a main current controller 11a, sub-current controllers 11b, 11c and 11d; a transmitter-receiver 12; converters 13a, 13b, 13c and 13d; and inverters 14a, 14b, 14c and 14d.

The motor control device 1 according to the present embodiment controls a motor 3 (e.g., servo motor, etc.) that includes the four windings 31a, 31b, 31c and 31d. The four windings 31a, 31b, 31c and 31d are respectively independent as electrical circuits.

The current command part 10a is connected with the numerical control 2, and supplies a current command to the main current controller 11a according to an instruction from the numerical control 2. In addition, the current command part 10a supplies the same current commands to the current command parts 10b, 10c and 10d. The current command parts 10b, 10c and 10d supply current commands to each of the sub-current controllers 11b, 11c and 11d, similarly to the current command part 10a.

The main current controller 11a is connected with the numerical control 2 via the current command part 10a, and controls the current flowing to the winding 31a according to the current command from the numerical control 2. In addition, the main current controller 11a is connected with a detection part 32 of the motor 3, and receives current feedback of the motor 3 detected by the detection part 32.

The sub-current controllers 11b, 11c and 11d are connected with the main current controller 11a via the transmitter-receiver 12, and control each of the currents flowing to the respective windings 31b, 31c and 31d according to the current command.

The transmitter-receiver 12 is connected with the main current controller 11a and the sub-current controllers 11b, 11c and 11d, and sends and receives data with each of the current controllers.

The converters 13a, 13b, 13c and 13d convert the AC electric power supplied from an AC power source (not illustrated) into DC electric power, and supplies to the respective inverters 14a, 14b, 14c and 14d, based on the control of the main current controller 11a and the sub-current controllers 11b, 11c and 11d.

The inverters 14a, 14b, 14c and 14d convert the DC electric power thus converted by the converters 13a, 13b, 13c and 13d into a desired AC electric power, and supply the AC electric power thus converted to the windings 31a, 31b, 31c and 31d of the motor 3.

Hereinafter, the processing of the motor control device 1 according to the present embodiment will be explained. The main current controller 11a acquires the states of the main current controller 11a and sub-current controllers 11b, 11c and 11d via the transmitter-receiver 12. The main current controller 11a calculates the states of the main current controller 11a and the sub-current controllers 11b, 11c and 11d, and compares the states of the main current controller 11a and the sub-current controllers 11b, 11c and 11d thus calculated.

Then, the main current controller 11a determines whether an abnormality has occurred in the main current controller 11a and the sub-current controllers 11b, 11c and 11d, based on the results from comparing the states of the main current controller 11a and the sub-current controllers 11b, 11c and 11d.

More specifically, in the case of the motor 3 generating a rotating magnetic field by way of three-phase alternating current, the main current controller 11a compares, as the states of the main current controller 11a and the sub-current controllers 11b, 11c and 11d, the average value for the feedback current of each R phase of the motor 3, and determines abnormality of the main current controller 11a and the sub-current controllers 11b, 11c and 11d.

For example, when defining the feedback current of each R phase of the four windings 31a, 31b, 31c and 31d as IRA, IRB, IRC and IRC, respectively, the main current controller 11a obtains:
(a) difference between the feedback current IRA, and the average value of feedback currents IRB, IRC and IRD,
(b) difference between the feedback current IRB, and the average value of feedback currents IRA, IRC and IRD,
(c) difference between the feedback current IRC, and the average value of feedback currents IRA, IRB and IRD, and
(d) difference between the feedback current IRD, and the average value of feedback currents IRA, IRB and IRC.

Then, the main current controller 11a determines that an abnormality is occurring in the main current controller 11a and sub-current controllers 11b, 11c and 11d, in the case of the above-mentioned four differences in current feedback being greater than a threshold set in advance. For example, the main current controller 11a determines that an abnormality is occurring in the sub-current controller 11b corresponding to the feedback current IRB, in the case of the difference between the feedback current IRB and the average value of feedback currents IRA, IRC and IRD being greater than a threshold set in advance.

It should be noted that, in the above-mentioned example, although the feedback current of the R phase of the motor 3 is used as the state of the main current controller 11a, and the sub-current controllers 11b, 11c and 11d, the feedback current of the S phase or the feedback current of the T phase of the motor 3 may be used. In addition, as the states of the main current controller 11a and sub-current controllers 11b, 11c and 11d, the feedback of a d-phase current or the feedback of a q-phase current arrived at by converting the three-phase coordinate system of the motor 3 into the dq rotary coordinate system may be used.

As another example, the main current controller 11a may calculate the logical sum (OR) of the states of the main current controller 11a and sub-current controllers 11b, 11c and 11d thus acquired, and compare one state among the main current controller 11a and sub-current controllers 11b, 11c and 11d thus calculated with the logical sum of the other states among the main current controller 11a and sub-current controllers 11b, 11c and 11d thus calculated.

For example, a state signal indicating an abnormal state of the main current controller 11a, and sub-current controllers 11b, 11c and 11d in the case of abnormality occurring is defined as the logical result of 0 or 1. Herein, the logical result for the state signal defines a normal case as 0, and a case of an abnormality occurring as 1. Then, the main current controller 11a compares the logical result of one among the states of the main current controller 11a, and sub-current controllers 11b, 11c and 11d, with the logical sum of the logical results of the other of the states of the main current controller 11a, and sub-current controllers 11b, 11c and 11d.

More specifically, the main current controller 11a:
(a) compares between the logical result of the main current controller 11a and the logical sum of the logical results of the sub-current controllers 11b, 11c and 11d;
(b) compares between the logical result of the sub-current controller 11b and the logical sum of the logical results of the main current controller 11a and sub-current controllers 11c and 11d;
(c) compares between the logical result of the sub-current controller 11c and the logical sum of the logical results of the main current controller 11a and sub-current controllers 11b and 11d; and
(d) compares between the logical result of the sub-current controller 11d and the logical sum of the logical results of the main current controller 11a and sub-current controllers 11b and 11c.

Then, the main current controller 11a determines that an abnormality is occurring in the main current controller 11a and sub-current controllers 11b, 11c and 11d having differing values, as a result of comparing between the above-mentioned four logical results and logical sum.

For example, in the case of the state signals indicating an abnormal state of the main current controller 11a and sub-current controllers 11b, 11c and 11d being 0, 0, 0 and 1, respectively, the main current controller 11a determines that the abnormality is occurring in the sub-current controller 11d, since the logical result (state signal of 1) of the sub-current controller 11d and the local sum (logical sum of state signals of 0) of the logical results of the main current controller 11a and sub-current controllers 11b and 11c are differing.

In addition, the main current controller 11a may compare the logical result of the state of one among the main current controller 11a and sub-current controllers 11b, 11c and 11d thus calculated with the logical product (AND) of the other states among the main current controller 11a and sub-current controllers 11b, 11c and 11d thus calculated, instead of comparing the above-mentioned such logical sum. More specifically, the main current controller 11a:
(a) compares between the logical result of the main current controller 11a and the logical product of the logical results of the sub-current controllers 11b, 11c and 11d;
(b) compares between the logical result of the sub-current controller 11b and the logical product of the logical results of the main current controller 11a and sub-current controllers 11c and 11d;
(c) compares between the logical result of the sub-current controller 11c and the logical product of the logical results of the main current controller 11a and sub-current controllers 11b and 11d; and
(d) compares between the logical result of the sub-current controller 11d and the logical product of the logical results of the main current controller 11a and sub-current controllers 11b and 11c.

Then, the main current controller 11a determines that an abnormality is occurring in the main current controller 11a and sub-current controllers 11b, 11c and 11d having differing values, as a result of comparing the four logical results and logical products.

For example, a preparation complete signal indicating a preparation completed state of the main current controller 11a and sub-current controllers 11b, 11c and 11d is set as the logical result of 0 or 1. Herein, the logical result for the preparation complete signal defines a case of being preparation complete as 1, and defines a state of not being preparation complete as 0.

Then, in the case of the preparation complete signals indicating the preparation complete state of the main current controller 11a and sub-current controllers 11b, 11c and 11d being 1, 1, 1 and 0, respectively, the main current controller 11a determines that there is an abnormality occurring in the sub-current controller 11d, due to the logical result of the sub-current controller 11d (preparation complete signal of 0) and the logical product of the logical results of the main current controller 11a and sub-current controllers 11b and 11c (logical product of preparation complete signals of 1) differing.

As yet another example, the main current controller 11a may calculate the states of the main current controller 11a, and sub-current controllers 11b, 11c and 11d thus acquired, respectively compare the states among the main current controller 11a and sub-current controllers 11b, 11c and 11d thus calculated, and count the number of the same states among the main current controller 11a, and sub-current controllers 11b, 11c and 11d. Then, the main current controller 11a determines if an abnormality is occurring in the main current controller 11a, and sub-current controllers 11b, 11c and 11d, which is in the state having a small number of the same states.

For example, the main current controller 11a, in the case of the logical results of the states of the main current controller 11a, and sub-current controllers 11b, 11c and 11d thus calculated being 0, 0, 0 and 1, respectively, determines that an abnormality is occurring in the sub-current controller 11d, which is in the state having a small number of same states, due to there being three of the logical result 0 (main current controller 11a, sub-current controllers 11b and 11c), and there being one of the logical result 1 (sub-current controller 11d).

In the case of determining that an abnormality is occurring in at least one of the main current controller 11a, and sub-current controllers 11b, 11c and 11d according to the above-mentioned such processing, the main current controller 11a sends an abnormality notification of the main current controller 11a, and sub-current controllers 11b, 11c and 11d, and information of the windings 31a, 31b, 31c and 31d corresponding to the main current controller 11a, and sub-current controllers 11b, 11c and 11d for which an abnormality occurred to the numerical control 2. The numerical control 2 informs, in a predetermined mode, the user of an abnormality notification of the main current controller 11, and sub-current controllers 11b, 11c and 11d, and the information of the windings 31a, 31b, 31c and 31d corresponding to the main current controller 11a, and sub-current controllers 11b, 11c and 11d, for which an abnormality occurred.

For example, the main current controller 11a sends, to the numerical control 2, an abnormality notification of the sub-current controller 11b and ID information of the winding 31b corresponding to the sub-current controller 11b, in the case of the abnormality occurring in the sub-current controller 11b. It should be noted that the ID information of the winding is uniquely decided for every winding. Then, the numerical control 2 informs the user, by a predetermined mode (for example, display on a display device, alarm sound, etc.), of an abnormality notification of the sub-current controller 11b and the ID information of the winding 31b corresponding to the sub-current controller 11b.

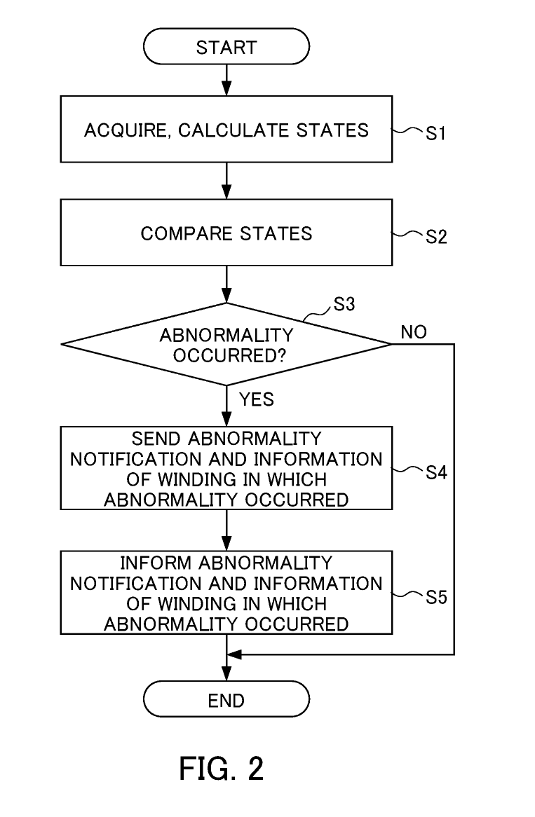

FIG. 2 is a view showing an example of the processing of the motor control device 1 according to the embodiment of the present invention. In Step S1, the main current controller 11a acquires the states of the main current controller 11a, and sub-current controllers 11b, 11c and 11d via the transmitter-receiver 12, and calculates the states of the main current controller 11a and sub-current controllers 11b, 11c and 11d thus acquired.

In Step S2, the main current controller 11a compares the states of the main current controller 11a and sub-current controllers 11b, 11c and 11d thus calculated.

In Step S3, the main current controller 11a determines if an abnormality is occurring in the main current controller 11a and sub-current controllers 11b, 11c and 11d, based on the results of comparing the states of the main current controller 11a, and sub-current controllers 11b, 11c and 11d. The main current controller 11a, in the case of determining that an abnormality is occurring in the main current controller 11a, sub-current controllers 11b, 11c and 11d (YES), advances to Step S4. The main current controller 11a, in the case of determining that an abnormality is not occurring in the main current controller 11a, sub-current controllers 11b, 11c and 11d (NO), ends the processing.

In Step S4, the main current controller 11a, in the case of determining that an abnormality is occurring in the main current controller 11a, and sub-current controllers 11b, 11c and 11d, sends to the numerical control 2 an abnormality notification of the main current controller 11a, and sub-current controllers 11b, 11c and 11d and ID information of the windings 31a, 31b, 31c and 31d corresponding to the main current controller 11a, and sub-current controllers 11b, 11c and 11d for which an abnormality occurred.

In Step S5, the numerical control 2 informs the user, by a predetermined mode, an abnormality notification of the main current controller 11a, and sub-current controllers 11b, 11c and 11d for which an abnormality occurred, and ID information of the windings 31a, 31b, 31c and 31d for which abnormality occurred. The user can thereby recognize in which winding the abnormality is occurring.

According to the present embodiment, the motor control device 1 compares the states of the main current controller 11a, and sub-current controllers 11b, 11c and 11d calculated, and determines if an abnormality is occurring based on the result of comparing the states. Consequently, the motor control device 1 can determine that an abnormality is occurring in the current controllers using the results of comparing the states of the main current controller 11a, and sub-current controllers 11b, 11c and 11d, and can reduce the load of arithmetic processing on the motor control device 1 by way of simple arithmetic processing.

In addition, the motor control device 1 determines that an abnormality is occurring in the case of the difference between average values of feedback currents of the main current controller 11a, and sub-current controllers 11b, 11c and 11d being greater than a threshold. The processing for obtaining the difference of average values of feedback current, for example, is a simple calculation compared to a case of obtaining a ratio of error of feedback currents, or the like, and thus can reduce the load of arithmetic processing on the motor control device 1.

In addition, the motor control device 1 determines that an abnormality is occurring in the case of the logical sum or logical product of states of the main current controller 11a, and sub-current controllers 11b, 11c and 11d differing. By determining an abnormality using the logical sum or logical product, the motor control device 1 can accurately determine an abnormality, as well as reducing the load of arithmetic processing.

In addition, the motor control device 1 counts the number of same states among the main current controller 11a, and sub-current controllers 11b, 11c and 11d, and determines that an abnormality is occurring in the main current controller 11a, and sub-current controllers 11b, 11c and 11d which is in the state having a small number of same states. It is thereby possible for the motor control device 1 to accurately determine an abnormality similarly for the logical sum or logical product, and reduce the load of arithmetic processing.

In addition, the motor control device 1, in the case of determining that an abnormality is occurring, sends an abnormality notification of the main current controller 11a, and sub-current controllers 11b, 11c and 11d, and information of the windings 31a, 31b, 31c and 31d for which the abnormality occurred to the numerical control 2. Then, the numerical control 2 informs the user, by a predetermined mode, the abnormality notification of the main current controller 11a, and sub-current controllers 11b, 11c and 11d for which the abnormality occurred, and information of the windings 31a, 31b, 31c and 31d for which the abnormality occurred. It is thereby possible for the user to recognize in which winding the abnormality is occurring.

Although an embodiment of the present invention has been explained above, the present invention is not to be limited to the aforementioned embodiment. In addition, the effects described in the present embodiment are merely listing the most preferred effects produced from the present invention, and the effects according to the present invention are not to be limited to those described in the present embodiment.

### EXPLANATION OF REFERENCE NUMERALS

1 motor control device
2 numerical control
3 motor
10a, 10b, 10c, 10d current command part
11a main current controller
11b, 11c, 11d sub-current controller
12 transmitter-receiver
13a, 13b, 13c, 13d converter
14a, 14b, 14c, 14d inverter
31a, 31b, 31c, 31d winding
32 detection part

What is claimed is:

1. A control device for a motor having a plurality of windings, the device comprising:
a main current controller that is connected with a numerical control and controls current flowing to one winding among the plurality of windings; and
sub-current controllers that are connected with the main current controller and control current flowing to each of other windings among the plurality of windings, respectively,
wherein the main current controller:
calculates states of the main current controller and the sub-current controllers,
compares between the states of the main current controller and the sub-current controllers thus calculated, and
determines whether an abnormality is occurring in the main current controller and the sub-current controllers based on a result of comparing between the states of the main current controller and the sub-current controllers.

2. The control device for a motor according to claim 1,
wherein the main current controller:
calculates an average value for the states of the main current controller and the sub-current controllers,
compares between a value of one state among the main current controller and the sub-current controllers with an average value of other states among the main current controller and the sub-current controllers, and
determines that an abnormality is occurring in the main current controller and the sub-current controllers, in a case of a difference between the value of the one state and the average value of the other states being greater than a threshold.

3. The control device for a motor according to claim 1,
wherein the main current controller:
calculates a logical sum of the states of the main current controller and the sub-current controllers,
compares between one state among the main current controller and the sub-current controllers with a logical sum of other states among the main current controller and the sub-current controllers, and
determines that an abnormality is occurring in the main current controller and the sub-current controllers, in a case of the one state and the logical sum of the other states being different.

4. The control device for a motor according to claim 1,
wherein the main current controller:
calculates a logical product of the states of the main current controller and the sub-current controllers,
compares between one state of among the main current controller and the sub-current controllers with a logical product of other states among the main current controller and the sub-current controllers, and
determines that an abnormality is occurring in the main current controller and the sub-current controllers, in a case of the one state and the logical product of the other states being different.

5. The control device for a motor according to claim 1,
wherein the main current controller:
calculates states of the main current controller and the sub-current controllers,
compares between the states of the main current controller and the sub-current controllers, respectively, and
counts a number of same states among the states of the main current controller and the sub-current controllers, and determines that an abnormality is occurring in the main current controller and the sub-current controllers, which is in a state having a small number of the same states.

6. The control device for a motor according to claim 1,
wherein the main current controller,
in a case of determining that an abnormality is occurring in the main current controller and the sub-current controllers,
sends an abnormality notification of the main current controller and the sub-current controllers, and information of windings corresponding to the main current controller and the sub-current controllers in which an abnormality occurred, to the numerical control, and
wherein the numerical control informs, by a predetermined mode, the abnormality notification of the main current controller and the sub-current controllers, and the information of windings corresponding to the main current controller and the sub-current controllers in which the abnormality occurred.
